(19) United States
(12) Patent Application Publication
(10) Pub. No.: US 2016/0295889 A1
(43) Pub. Date: Oct. 13, 2016

(54) PROCESS FOR PREPARING SHELF STABLE FRESH NOODLES

(71) Applicants: Choon Kwang TAN, Singapore (SG); TAN SENG KEE FOODS PTE. LTD., Singapore (SG)

(72) Inventor: Choon Kwang Tan, Singapore (SG)

(21) Appl. No.: 15/038,418

(22) PCT Filed: Nov. 21, 2014
(86) PCT No.: PCT/SG2014/000554

§ 371 Date: May 20, 2016

(30) Foreign Application Priority Data
Nov. 21, 2013 (SG) 201308632-7

(51) Int. Cl. A23L 1/16; A23L 3/10

(52) U.S. Cl. CPC A23L 1/162; A23L 3/10; A23V 2002/00

(57) ABSTRACT

The present invention relates generally to a process for preparing shelf stable fresh noodles, and particularly to wheat-based and rice-based fresh noodles. The present invention includes a process comprising subjecting weighed and packaged wheat-based noodles, which are prepared in a manner known to those skilled in the art, to pasteurisation at a specified temperature range and duration or subjecting weighed and packaged rice-based noodles, which are prepared in a manner known to those skilled in the art, to pasteurisation at a specified temperature range and duration, to obtain shelf stable fresh noodles.

### FIELD OF THE INVENTION

The present invention relates generally to a process for preparing shelf stable fresh noodles, and particularly to wheat-based and rice-based fresh noodles.

### BACKGROUND OF THE INVENTION

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

Fresh noodles such as wheat-based and rice-based noodles without proper refrigeration have a short shelf life that only last for one to three days before becoming unsuitable for use or consumption. To extend the short shelf life for one or two more days, fresh noodles can be sold in refrigerators or chillers at the supermarkets and shops, However, fresh noodles that are refrigerated or chilled tend to harden, thus compromising the texture of fresh noodles.

There are several methods or treatments available for extending the shelf life of fresh noodles including sterilization treatment with hydrogen peroxide, retort treatment, lysozyme treatment and chemical treatments such as addition of alcohol and lower fatty acid esters to the noodles. However, there are many disadvantages associated with such methods or treatments such as adverse effect on human health, increased cost of production and the texture, colour and/or taste of the treated noodles being sacrificed.

U.S. Pat. No. 4,552,772 to Saitoh et al describes a combination use of citric and/or lactic acid with table salt in one solution to enhance the preservability of boiled noodle products to be commercially distributed at an ambient temperature. Boiled noodles are subjected to immersion treatment with the aqueous solution containing said combination and then, without rinsing, packaged and heat sterilized for commercial distribution, said aqueous solution having a pH such that the pH of the boiled noodles after immersion is about 3.9 to about 4.3. Additional use of sodium glutamate is proposed for improving palatability if desired.

The process described in Saitoh et al requires additional steps of preparing a suitable aqueous solution with citric and/or lactic acid with an appropriate pH and immersion of the boiled noodles in said aqueous solution to obtain a pH of about 3.9 to about 4.3, which can be tedious as compared to conventional processes for preparing noodles for commercial distribution. Furthermore, the treated noodles, due to their low pH, will have a strong acid taste, will suffer from severe roughness when they are boiled, will be too soft, and they will mutually adhere to one another or suffer from roughness when they are fried in a hot pan. Although Saitoh et al teaches the use of adding sodium glutamate for improving palatability, the texture of the treated noodles still remains compromised due to the acid treatment.

There are also methods for treating Japanese Udon Noodles to extend the shelf life which engage aseptic heat treatment with vacuum packaging of the noodles. Although such treatment is able to extend the shelf life of Japanese Udon Noodles at ambient temperature, said treatment is costly which results in a high selling price of the treated noodles and it also affects the colour and/or texture of wheat-based and rice-based noodles which is highly undesirable.

Therefore, there is a need to provide a process for preparing shelf stable fresh noodles, and particularly to wheat-based and rice-based fresh noodles that overcomes, or at least alleviates, the above-mentioned problems.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In accordance with a first aspect of the present invention, there is provided a process for preparing shelf stable fresh noodles, and particularly to wheat-based and rice-based fresh noodles. The process comprises subjecting weighed and packaged wheat-based noodles, which are prepared in a manner known to those skilled in the art, to pasteurisation at a specified temperature range of about 75 to about 95 degree Celsius for a period of about 10 to about 30 minutes or subjecting weighed and packaged rice-based noodles, which are prepared in a manner known to those skilled in the art, to pasteurisation at a specified temperature range of about 85 to about 100 degree Celsius for a period of about 15 to 50 minutes.

Preferably, the pasteurisation parameters for wheat-based noodles are at a temperature range of about 75 to about 90 degree Celsius for a period of about 15 to about 25 minutes. More preferably, the pasteurisation parameters for wheat-based noodles are at a temperature range of about 80 to about 90 degree Celsius for a period of about 15 to about 20 minutes.

Preferably, the pasteurisation parameters for rice-based noodles are at a temperature range of about 85 to about 95 degree Celsius for a period of about 25 to about 45 minutes. More preferably, the pasteurisation parameters for rice-based noodles are at a temperature range of about 85 to about 95 degree Celsius for a period of about 30 to about 45 minutes.

By utilizing the present invention for the preparation of fresh noodles, surprisingly it is now possible to extend the shelf life of fresh noodles at ambient temperature without affecting organoleptic properties of the fresh noodles such as the taste, texture, colour and mouthfeel and at a reasonable selling price. Advantageously, the shelf life of fresh noodles is extended from a mere one to three days to at least two weeks to one month at ambient temperature. Advantageously, the shelf life of fresh noodles is extended to at least six months if kept chilled at 4 to 7 degree Celsius. Advantageously, the shelf life of fresh noodles is extended to at least one year if kept frozen.

Preferably, after the wheat-based noodles are formed, which is prepared in a manner known to those skilled in the art, they are subjected to an additional step of steaming prior to conventional cooking of the noodles to advantageously prevent the noodles from turning slimy after being subjected to the pasteurisation process for wheat-based noodles mentioned above. This additional step of steaming the noodles also advantageously contributes to the strength of the noodle texture.

Preferably, the packaging used to package the wheat-based or rice-based noodles comprises nylon and Linear Low Density Polyethylene (“LLDPE”) which advantageously serves as a good barrier for the external environment to come into contact with the packaged noodles and at the same time prevents the noodles from all contact of bacterial contamination. In addition and advantageously, the packaging used to package the wheat-based or rice-based noodles is Bisphenol A (“BPA”) free.

In accordance with a second aspect of the invention there is a process for preparing packaged shelf-stable fresh noodles, comprising the step of subjecting the packaged noodles to pasteurisation at a temperature from about 70 to about 105° C. for a holding period from about 5 to about 55 minutes.

Preferably, the packaged noodles include wheat-based packaged noodles and rice-based packaged noodles.

Preferably, the rice-based packaged noodles are subjected to pasteurisation at a temperature from about 80 to about 95° C.

Preferably, the rice-based packaged noodles are subjected to pasteurisation at a temperature from about 85 to about 90° C.

Preferably, the rice-based packaged noodles are subjected to pasteurisation for a period from about 15 to about 50 minutes.

Preferably, the rice-based packaged noodles are subjected to pasteurisation for a period from about 20 to about 45 minutes.

Preferably, the rice-based packaged noodles are subjected to pasteurisation for a period from about 20 to about 35 minutes.

Preferably, the wheat-based packaged noodles are subjected to pasteurisation at a temperature from about 70 to about 95° C.

Preferably, the wheat-based packaged noodles are subjected to pasteurisation at a temperature from about 70 to about 85° C.

Preferably, the wheat-based packaged noodles are subjected to pasteurisation at a temperature from about 70 to about 80° C.

Preferably, the wheat-based packaged noodles are subjected to pasteurisation for a period from about 5 to about 30 minutes.

Preferably, the wheat-based packaged noodles are subjected to pasteurisation for a period from about 5 to about 25 minutes.

Preferably, the wheat-based packaged noodles are subjected to pasteurisation for a period from about 5 to about 20 minutes.

Preferably, the preparation of the packaged noodles includes a step of conventional cooking before packaging.

Preferably, prior to the step of conventional cooking, the noodles is subjected to water steaming for a period from 3 to 15 minutes.

Preferably, after the step of conventional cooking and prior to packaging, the noodles are subjected to rinsing with an aqueous solution having a pH such that the pH of the cooked noodles after rinsing is about 3.0 to about 12.

Preferably, the pH of the cooked noodles after rinsing is about 3.0 to 4.5.

Preferably, the pH of the cooked noodles after rinsing is about 9.0 to 11.0.

Process according to any of the preceding claims, wherein the packaging used to package the noodles comprises nylon and linear low density polyethylene.

In accordance with a third aspect of the invention there comprises packaged shelf-stable fresh noodles obtainable by the process described in any of the preceding aspects. The packaged shelf-stable fresh noodles obtainable by the process may be wheat-based noodles or rice-based noodles.

Other aspects and features of the present invention will become apparent to those of ordinary skill in the art upon review of the following description of specific embodiments of the invention.

### DETAILED DESCRIPTION OF EXEMPLARY EMBODIMENTS

The process of the present invention is applicable to wheat-based noodles and rice-based fresh noodles.

The term, “wheat-based”, as used herein should be understood in the broadest sense to cover any kinds of noodles mainly composed of wheat flour added with or without eggs or yolks and added with or without any other additives. Examples of wheat-based noodles include, but are not limited to, Hokkien Noodles, Hokkien Flat Noodles, Mee Pok Noodles, Mee Kia Noodles, La Mian, Ban Mian, macaroni, wanton skin, dumpling skin, Popiah skin, pasta and Japanese style noodles such as ramen and udon.

The term, “rice-based”, as used herein should be understood in the broadest sense to cover any kinds of noodles mainly composed of one or more of rice flour, rice grinded into liquid form and starches, added with or without eggs or yolks and added with or without any other additives. Examples of rice-based noodles include, but are not limited to, Kway Teow, Ipoh Hor Fun, Hor Fun, Kway Chap, Bee Tai Mak, Laksa Noodles, Bee Hoon, rice noodle roll (also known as Chee Cheong Fun), Chwee Kueh and turnip cake (also known as radish cake or carrot cake).

The term, “fresh noodles” or “noodles”, as used herein refers to all kinds of wheat-based and rice-based noodles that are not in the dried form such as dried noodles or instant noodles.

By utilizing the present invention for the preparation of fresh noodles, surprisingly it is now possible to extend the shelf life of fresh noodles at ambient temperature without affecting organoleptic properties of the fresh noodles such as the taste, texture, colour and mouthfeel and at a reasonable selling price. Advantageously, the shelf life of fresh noodles is extended from a mere one to three days to at least two weeks to one month at ambient temperature. Advantageously, the shelf life of fresh noodles is extended to at least six months if kept chilled at about 4 to about 7 degree Celsius. Advantageously, the shelf life of fresh noodles is extended to at least one year if kept frozen.

Wheat-based noodles which are to be treated according to the process of the present invention are prepared in a manner known to those skilled in the art. That is, starting materials for making wheat-based noodles, such as wheat flour or the like, are charged with appropriate amounts of water, eggs or yolks, if desired, and additives, if desired, and then mixed or kneaded to form dough.

In order to facilitate further the understanding of the above and the process of the present invention, the process of obtaining wheat-based fresh noodles is described hereinafter using Hokkien Noodles as an example in accordance with an embodiment of the present invention.

The starting materials for making Hokkien Noodles include wheat flour, potassium chloride and/or caustic soda, common salt, permitted colouring which includes tartrazine code E102 and oil such as edible vegetable oil. Flavour enhancers such as E524 or E500i and E501i can also be added. First, each of the common salt and the colouring E102 is made into a solution and is individually mixed. The caustic soda is also individually mixed. Thereafter, the mixed common salt solution, the mixed colouring E102 solution and the mixed caustic soda are combined together for further mixing to obtain a combined mixture. Wheat flour is then added to the combined mixture to obtain a flour mixture that is mixed and blended. After the mixing and blending of the flour mixture, a dough compound is obtained and is pressed so as to obtain a dough sheet. The dough sheet is then compressed and cut into the desired shape and thickness to form noodles that are cooked, for example, at about 100 degree Celsius. The cooked noodles are washed with water and oil is then added to the noodles. Thereafter, the oiled noodles are cooled, weighed and packaged. Each package contains about 420 g of noodles. Each package can also contain more than 420 g of noodles or less than 420 g of noodles. Preferably, each package contains about 1.5 kg or less of noodles. The above-mentioned processes or steps are known to those skilled in the art. The machinery used to carry out the processes or steps, if any, is also known to those skilled in the art.

The inventors of the present invention have discovered that surprisingly it is now possible achieve wheat-based fresh noodles with extended shelf life at ambient temperature without affecting organoleptic properties of the fresh noodles such as the taste, texture, colour and mouthfeel and at a reasonable selling price by subjecting the packaged noodles to pasteurisation at a particular temperature range and duration. Specifically, the packaged wheat-based noodles are pasteurised at a temperature range of about 75 to about 95 degree Celsius for a period of about 10 to about 30 minutes. Preferably, the pasteurisation parameters are at a temperature range of about 75 to about 90 degree Celsius for a period of about 15 to about 25 minutes. More preferably, the pasteurisation parameters for wheat-based noodles are at a temperature range of about 80 to about 90 degree Celsius for a period of about 15 to about 20 minutes. In another embodiment, the packaged wheat-based noodles may also be pasteurized at a temperature range of about 70 to about 95 degree Celsius for a period of about 5 to about 30 minutes. Preferably, the pasteurisation parameters are at a temperature range of about 70 to about 85 degree Celsius for a period of about 5 to about 25 minutes. More preferably, the pasteurisation parameters for wheat-based noodles are at a temperature range of about 70 to about 80 degree Celsius for a period of about 5 to about 20 minutes. The lower temperature and/or holding period relative to the preceding embodiment may be achieved in part due to techniques providing even and homogeneous heating to the packaged wheat-based noodles.

The parameters for pasteurisation are very important as utilising high heat treatment to remove or reduce harmful microorganisms so as to extend the shelf life of the fresh noodles would inevitably affect the one or more organoleptic property of the fresh noodles, which is undesirable. Thus, it is important and advantageous that the pasteurisation of the packaged wheat-based noodles is carried out at the specified temperature range and duration mentioned above.

Preferably, after the noodles are formed, they are subjected to an additional step of steaming prior to the cooking of the noodles to advantageously prevent the noodles from turning into a darker colour after being subjected to the pasteurisation process mentioned above. This additional step of steaming the noodles also advantageously contributes to the strength of the noodle texture. However, this additional process may result in lesser yield as it prevents better absorption of water in the noodles during boiling. The additional step of steaming prior to the cooking of the noodles may take place at a duration of between about 3 to about 15 minutes.

After the packaged noodles are pasteurised, the wheat-based fresh noodles are ready to be delivered for retailing. The wheat-based fresh noodles can be retailed or commercially distributed at ambient temperatures and are ready for cooking. The wheat-based fresh noodles after being treated according to the process of the present invention have a lighter alkaline taste (non-bitter after taste), a slightly translucent appearance and have a texture that is smooth, firm, and springy. The wheat-based fresh noodles also have a more natural and lighter yellow hue colour.

With the pasteurisation step carried out at the specified temperature range and duration mentioned above for wheat-based noodles, aseptic heat treatment with vacuum packaging that is being employed to extend the shelf life of Japanese Udon Noodles at ambient temperature, which is very costly and affects the colour and/or texture of wheat-based and rice-based noodles, is not required in the present invention.

Advantageously, the packaging used to package the wheat-based noodles comprises nylon and Linear Low Density Polyethylene (“LLDPE”) which advantageously serves as a good barrier for the external environment to come into contact with the packaged noodles and at the same time prevents the noodles from all contact of bacterial contamination. In addition and advantageously, the packaging used to package the wheat-based noodles is Bisphenol A (“BPA”) free.

It would be understood that other kinds of wheat-based noodles such as Hokkien Flat Noodles, Mee Pok Noodles, Mee Kia Noodles, La Mian, Ban Mian, macaroni, wanton skin, dumpling skin, Popiah skin, pasta and Japanese style noodles such as ramen and udon when treated with the process of the present invention would also achieve wheat-based fresh noodles with extended shelf life at ambient temperature without affecting organoleptic properties of the fresh noodles such as the taste, texture, colour and mouthfeel and at a reasonable selling price.

Like wheat-based noodles, rice-based noodles which are to be treated according to the process of the present invention are also prepared in a manner known to those skilled in the art. That is, starting materials for making rice-based noodles, such as rice and/or rice flour or the like, are charged with appropriate amounts of water, starches, if desired, and additives, if desired, and then mixed to form a slurry.

In order to facilitate further the understanding of the above and the process of the present invention, the process of obtaining rice-based fresh noodles is described hereinafter using Kway Teow as an example in accordance with an embodiment of the present invention.

The starting materials for making Kway Teow include oil such as edible vegetable oil, rice and starch, the starch being formed from a mixture of corn, wheat, sago and tapioca. First, the rice is soaked in water before it is being washed with water and then ground. Thereafter, the starch is added to the ground rice and the mixture is mixed to obtain a slurry. The slurry is then sieved to smoothen the slurry and steamed to obtain rice sheets. After steaming, the rice sheets are cooled and oil is then added to the rice sheets. The oiled rice sheets are then cut into the desired shape and size to obtain Kway Teow before being weighed and packaged. Each package contains about 420 g of noodles. Each package can also contain more than 420 g of noodles or less than 420 g of noodles. Preferably, each package contains about 1.5 kg or less of noodles. The above-mentioned processes or steps are known to those skilled in the art. The machinery used to carry out the processes or steps, if any, is also known to those skilled in the art.

The inventors of the present invention have discovered that surprisingly it is now possible achieve rice-based fresh noodles with extended shelf life at ambient temperature without affecting organoleptic properties of the fresh noodles such as the taste, texture, colour and mouthfeel and at a reasonable selling price by subjecting the packaged noodles to pasteurisation at a particular temperature range and duration. Specifically, the packaged rice-based noodles are pasteurised at a temperature of about 85 to about 100 degree Celsius for a period of about 15 to about 50 minutes. Preferably, the pasteurisation parameters are at a temperature range of about 85 to about 95 degree Celsius for a period of about 25 to about 45 minutes. More preferably, the pasteurisation parameters for rice-based noodles are at a temperature range of about 85 to about 95 degree Celsius for a period of about 30 to about 45 minutes. In another embodiment, the packaged rice-based noodles may also be pasteurized at a temperature range of about 80 to about 95 degree Celsius for a period of about 5 to about 30 minutes. Preferably, the pasteurisation parameters are at a temperature range of about 85 to about 90 degree Celsius for a period of about 20 to about 45 minutes. More preferably, the pasteurisation parameters for rice-based noodles are at a temperature range of about 85 to about 90 degree Celsius for a period of about 20 to about 35 minutes. The lower temperature and/or holding period relative to the preceding embodiment may be achieved in part due to techniques providing even and homogeneous heating to the packaged rice-based noodles.

As discussed previously, the parameters for pasteurisation are very important as utilising high heat treatment to remove or reduce harmful microorganisms so as to extend the shelf life of the fresh noodles would inevitably affect the organoleptic properties of the fresh noodles, which is undesirable. Thus, it is important and advantageous that the pasteurisation of the packaged rice-based noodles is carried out at the specified temperature range and duration mentioned above.

After the packaged Kway Teow is pasteurised, the rice-based fresh noodles are ready to be delivered for retailing. The rice-based fresh noodles can be retailed or commercially distributed at ambient temperatures and are ready for cooking. The rice-based fresh noodles after being treated according to the process of the present invention have a tinge of vinegar taste to it giving it a more refreshing taste. The texture of the rice-based fresh noodles is smooth, firm, and springy. The rice-based fresh noodles are not too mushy after pasteurisation. Furthermore, the noodles strand is slightly translucent and has a clear and whitish colour that is desirable.

With the pasteurisation step carried out at the specified temperature range and duration mentioned above for rice-based noodles, aseptic heat treatment with vacuum packaging that is being employed to extend the shelf life of Japanese Udon Noodles at ambient temperature, which is very costly and affects the colour and/or texture of wheat-based and rice-based noodles, is not required in the present invention.

Advantageously, the packaging used to package the rice-based noodles comprises nylon and Linear Low Density Polyethylene (“LLDPE”) which advantageously serves as a good barrier for the external environment to come into contact with the packaged noodles and at the same time prevents the noodles from all contact of bacterial contamination. In addition and advantageously, the packaging used to package the rice-based noodles is Bisphenol A (“BPA”) free.

It would be understood that other kinds of rice-based fresh noodles such as Ipoh Hor Fun, Hor Fun, Kway Chap, Bee Tal Mak, Laksa Noodles, Bee Hoon, rice noodle roll (also known as Chee Cheong Fun), Chwee Kueh and turnip cake (also known as radish cake or carrot cake) when treated with the process of the present invention would also achieve rice-based fresh noodles with extended shelf life at ambient temperature without affecting organoleptic properties of the fresh noodles such as the taste, texture, colour and mouthfeel and at a reasonable selling price.

The process of obtaining rice-based fresh noodles is described hereinafter using Bee Tai Mak as another example in accordance with an embodiment of the present invention.

The starting materials for making Bee Tai Mak includes rice and starch, the starch being formed from a mixture of corn, wheat, sago and tapioca, which are the same as that for making Kway Teow. The steps for obtaining ground rice for Bee Tai Mak are as described above for obtaining ground rice for Kway Teow. However, for Bee Tai Mak, there is an additional step of adding hot water to the ground rice to form a paste and then cooling the paste before starch is being mixed with the paste. After the paste is being mixed with the starch, Bee Tai Mak is being formed in the desired shape and size. The formed Bee Tai Mak is then cooked followed by being sieved and rinsed in running water before being cooled. Thereafter, the Bee Tai Mak is oiled before it is being weighed and packaged. Each package contains about 420 g of noodles. Each package can also contain more than 420 g of noodles or less than 420 g of noodles. Preferably, each package contains about 1.5 kg or less of noodles. The above-mentioned processes or steps are known to those skilled in the art.

Similar to Kway Teow, after the packaged Bee Tai Mak is pasteurised at a temperature of about 85 to about 100 degree Celsius for a period of about 15 to about 50 minutes, the treated Bee Tai Mak is ready to be delivered for retailing. Preferably, the pasteurisation parameters are at a temperature range of about 85 to about 95 degree Celsius for a period of about 25 to about 45 minutes. More preferably, the pasteurisation parameters are at a temperature range of about 85 to about 95 degree Celsius for a period of about 30 to about 45 minutes.

The process of obtaining rice-based fresh noodles is described hereinafter using Laksa Noodles as another example in accordance with an embodiment of the present invention.

Laksa Noodles which are to be treated according to the process of the present invention are also prepared in a manner known to those skilled in the art. Preferably, after Laksa Noodles are formed, water containing an additive such as vinegar is added to loosen Laksa noodles before the same is weighed and packaged. Each package contains about 420 g of noodles. Each package can also contain more than 420 g of noodles or less than 420 g of noodles. Preferably, each package contains about 1.5 kg or less of noodles. Similar to Kway Teow and Bee Tai Mak, after the packaged Laksa Noodles are pasteurised at a temperature of about 85 to about 100 degree Celsius for a period of about 15 to about 50 minutes, the treated Laksa Noodles are ready to be delivered for retailing. Preferably, the pasteurisation parameters are at a temperature of about 85 to about 95 degree Celsius for a period of about 25 to about 45 minutes. More preferably, the pasteurisation parameters are at a temperature range of about 85 to about 95 degree Celsius for a period of about 30 to about 45 minutes.

Although Laksa Noodles are a type of rice-based fresh noodles and can be subjected to the pasteurisation parameters described above for rice-based fresh noodles, preferably Laksa Noodles are subjected to the pasteurisation parameters of wheat-based fresh noodles which is pasteurisation at a specified temperature range of about 75 to about 95 degree Celsius for a period of about 10 to about 30 minutes. Preferably, the pasteurisation parameters are at a temperature range of about 75 to about 90 degree Celsius for a period of about 15 to about 25 minutes. More preferably, the pasteurisation parameters are at a temperature range of about 80 to about 90 degree Celsius for a period of about 15 to about 20 minutes.

Although La Mian and Ban Mian are a type of wheat-based fresh noodles and can be subjected to the pasteurisation parameters described above for wheat-based fresh noodles, preferably La Mian and Ban Mian are subjected to the pasteurisation parameters of rice-based fresh noodles which is at a specified temperature range of about 85 to about 100 degree Celsius for a period of about 15 to about 50 minutes. Preferably, the pasteurisation parameters are at a temperature of about 85 to about 95 degree Celsius for a period of about 25 to about 45 minutes. More preferably, the pasteurisation parameters are at a temperature range of about 85 to about 95 degree Celsius for a period of about 30 to about 45 minutes.

The present invention may also be applied to other wheat-based or rice-based food products and is not limited to the examples mentioned above. As exemplified based on the examples of Laksa noodles, La Mian and Ban Mian, certain rice-based noodles may be subjected to pasteurisation parameters suitable for wheat-based fresh noodles; and certain wheat-based noodles may be subjected to pasteurisation parameters suitable for rice-based fresh noodles.

pH is another factor which may affect the shelf life of the packaged noodles. In general, the less pH neutral the packaged noodles, i.e. the more acidic or more alkaline the packaged noodles, the longer the shelf life, all other factors being constant. However, the acidity or alkalinity of the packaged noodles affect one or more organoleptic properties, and in particular, taste and mouthfeel. Therefore there is a need to achieve a balance between the competing objectives.

A pH range of 3.0 to 12.0 is an acceptable range discovered by the inventors. For certain type of noodles such as Japanese Udon, consumers are accustomed to the ‘sour’ taste associated with a relatively low pH value around 2.5 to 3.5. For other types of noodles, for example Hokkien noodles, consumers are accustomed to the ‘light bitter’ or ‘bitter’ taste associated with a relatively high pH value of 8.0 to 10.0. These sourly or bitter taste may have in time become associated with the ‘authentic’ taste of the noodles which makes it easier to introduce into the preparation process.

Acidity or alkalinity may be introduced into the noodles after the step of conventional cooking and prior to packaging, where the noodles are subjected to rinsing with an aqueous solution having a desired pH according to the type of noodles.

Alternatively, acidity or alkalinity may be introduced into the noodles during the formation and formulation of the noodles.

To further ensure that the fresh noodles are safe for consumption or at least to reduce the risks of allergenic, chemical and biological hazards in the production processes described above to safe levels, Good Manufacturing Practice (“GMP”) and the Hazard Analysis and Critical Control Points (“HACCP”) approach is used for the production of the fresh noodles according to the present invention.

For wheat-based fresh noodles, the first check point is at the process step of cooking the noodles and the second check point is at the process step of pasteurising the noodles following the HACCP approach. For the rice-based fresh noodles, the first check point is at the process step of steaming or cooking the noodles and the second check point is at the process step of pasteurising the noodles following the HACCP approach.

The objective of these check points is to ensure that the bacteria/microbial count in the noodles at each of these check points is within the limits stipulated by the relevant authorities and/or law, for example, the Agri-Food & Veterinary Authority in Singapore. At each of these check points, there will be critical limits, monitoring procedures, deviations procedures, verification procedures and HACCP records.

In relation to critical limits for the first check point, there is a time and temperature control to achieve the desired lethality of 6 log reduction in bacteria count. It must be ensured at this stage that the central part of the food, in this case noodles, reaches a minimum of about 70 degree Celsius for about 2 minutes.

In relation to monitoring procedures for the first check point, during the cooking or steaming process, assigned production staff will measure and record the reading of the temperature gauge mounted in the cooking section of the machine that is used for cooking or steaming every 2 hours. The temperature recorded will be verified by Quality Assurance (“QA”).

In relation to deviation procedures for the first check point, QA will segregate and hold all affected products that do not meet the minimum requirements that have been set out. QA assures that the cause of the deviation is identified and the product reworked or condemned according to guidelines imposed upon by the Management.

In relation to verification procedures for the first check point, a supervisor will verify the accuracy of the temperature recording charts at least once per shift. QA will verify all thermometers used for monitoring and verification for accuracy every month and calibrate the same as necessary or whenever required.

In relation to HACCP records for the first check point, there will be a product temperature log, a thermometer calibration log and a corrective action log.

Turning to the second check point which is at the process step of pasteurising the noodles, in relation to critical limits, there is a time and temperature control to achieve sufficient level of destruction of microorganisms for extended product shelf life. The preferred temperature is in the range of about 75 to about 95 degree Celsius for duration of about 10 to about 30 minutes for wheat-based noodles and at about 85 to about 100 degree Celsius for duration of about 15 to about 50 minutes for rice-based noodles.

In relation to monitoring procedures for the second check point, during the pasteurisation process, the internal temperature of the pasteurising equipment is held at about 75 to about 95 degree Celsius for wheat-based noodles and at about 85 to about 100 degree Celsius for rice-based noodles. The production staff will record the pasteurisation value (time) as “Stage 1” for the batch that completed the cycle for wheat-based noodles and record the pasteurisation value (time) as “Stage 2” for the batch that completed the cycle for rice-based noodles. The records will be verified by QA.

In relation to deviation procedures for the second check point, QA will segregate and hold all affected products that do not meet the minimum requirements that have been set out. QA assures that the cause of the deviation is identified and the product reworked or condemned according to guidelines imposed upon by the Management. This is similar to deviation procedures for the first check point.

In relation to verification procedures for the second check point, a supervisor will verify the accuracy of the records monthly. QA will verify all thermometers used for monitoring and verification for accuracy every month and calibrate the same as necessary or whenever required. Shelf life tests are also carried out to verify the effectiveness of the process parameters.

In relation to HACCP records for the second check point, there will be a pasteurisation log, a thermometer calibration log, shelf life test records and a corrective action log.

Other features, benefits and advantages of the present invention not expressly mentioned above can be understood from this description by those skilled in the art. In particular, the temperature for pasteurisation may possibly be reduced to any value above 60° C. and the holding time reduced if pasteurization technology improves resulting in more homogenous and even heating of the packed noodles, for example.

Although the foregoing invention has been described in some detail by way of illustration and example, and with regard to one or more embodiments, for the purposes of clarity of understanding, it is readily apparent to those of ordinary skill in the art in light of the novel teachings and advantages of this invention that certain changes, variations and modifications may be made thereto without departing from the spirit or scope of the invention as described.

It would be further appreciated that although the invention covers individual embodiments, it also includes combinations of the embodiments discussed. For example, the features described in one embodiment is not being mutually exclusive to a feature described in another embodiment, and may be combined to form yet further embodiments of the invention.

1. A process for preparing packaged shelf-stable wheat-based fresh noodles, comprising the steps of subjecting the noodles to water steaming and conventional cooking before packaging wherein the pH of the cooked noodles after rinsing is about 9.0 to 11.0; and subjecting the packaged noodles to pasteurisation at a temperature from about 70 to about 105° C. for a period from about 5 to about 55 minutes.

2. A process for preparing packaged shelf-stable rice-based packaged fresh noodles, comprising the steps of grinding rice forming noodles; and subjecting the packaged noodles to pasteurisation by providing even and homogenous heating at a temperature from about 70 to about 105° C. for a period from about 5 to about 55 minutes.

3. The process according to claim 2, wherein the rice-based packaged noodles are subjected to pasteurisation at a temperature from about 80 to about 95° C.

4. The process according to claim 2, wherein the rice-based packaged noodles are subjected to pasteurisation at a temperature from about 85 to about 90° C.

5. The process according to claim 2, wherein the rice-based packaged noodles are subjected to pasteurisation for a period from about 15 to about 50 minutes.

6. The process according to claim 2, wherein the rice-based packaged noodles are subjected to pasteurisation for a period from about 20 to about 45 minutes.

7. The process according to claim 2, wherein the rice-based packaged noodles are subjected to pasteurisation for a period from about 20 to about 35 minutes.

8. The process according to claim 1, wherein the wheat-based packaged noodles are subjected to pasteurisation at a temperature from about 70 to about 95° C.

9. The process according to claim 1, wherein the wheat-based packaged noodles are subjected to pasteurisation at a temperature from about 70 to about 85° C.

10. The process according to claim 1, wherein the wheat-based packaged noodles are subjected to pasteurisation at a temperature from about 70 to about 80° C.

11. The process according to claim 1, wherein the wheat-based packaged noodles are subjected to pasteurisation for a period from about 5 to about 30 minutes.

12. The process according to claim 1, wherein the wheat-based packaged noodles are subjected to pasteurisation for a period from about 5 to about 25 minutes.

13. The process according to claim 1, wherein the wheat-based packaged noodles are subjected to pasteurisation for a period from about 5 to about 20 minutes.

14. The process according to claim 1, wherein the noodles are steamed for a period from 3 to 15 minutes.

15. The process according to claim 2, wherein the ground rice is mixed to obtain a slurry and is subjected to steaming to form rice sheets.

16. The process according to claim 2, wherein, prior to packaging, the noodles are subjected to rinsing with an aqueous solution having a pH such that the pH of the cooked noodles after rinsing is about 3.0 to about 4.5.

17. Process according to claim 1, wherein the packaging used to package the noodles comprises nylon and linear low density polyethylene.

18. (canceled)

19. Packaged shelf-stable fresh noodles obtainable by a process of claim 1.

20. Packaged shelf-stable fresh noodles obtainable by a process of claim 2.

21. Process according to claim 2, wherein the packaging used to package the noodles comprises nylon and linear low density polyethylene.
